(19) United States
(12) Patent Application Publication
(10) Pub. No.: US 2022/0416690 A1
(43) Pub. Date: Dec. 29, 2022

(54) KEYBOARD-BASED CHARGER FORBATTERIES

(71) Applicant: Hewlett-Packard Development Company, L.P., Spring, TX (US)

(72) Inventors: Harsha Punjabi, Pune (IN); Anurag Surendra Sharma, Pune (IN); Narendra Kumar Chincholikar, Pune (IN)

(21) Appl. No.: 17/846,348

(22) Filed: Jun. 22, 2022

(30) Foreign Application Priority Data
Jun. 26, 2021 (IN) 202141028804

(51) Int. Cl. H02N 2/18; G06F 3/02; H02J 7/00

(52) U.S. Cl. CPC H02N 2/18; G06F 3/0219; H02J 7/0042

(57) ABSTRACT

In one example in accordance with the present disclosure, an electronic device is described. An example electronic device includes a battery to provide power to the electronic device, a keyboard, and a keyboard-based charger to charge the battery by actuation of the keyboard. The example electronic device also includes a processor and memory storing executable instructions that when executed cause the processor to determine that a battery power is less than a threshold battery power and a power source is unavailable. The instructions also cause the processor to activate keyboard-based charging to charge the battery in response to determining that the battery power is less than the threshold battery power and a power source is unavailable. The instructions further cause the processor to generate a user notification to request keystrokes on the keyboard to charge the battery with the keyboard-based charger.

### BACKGROUND

Electronic technology has advanced to become virtually ubiquitous in society and has been used to improve many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1A is a block diagram of an electronic device to activate keyboard-based charging to charge a battery, according to an example.

FIG. 1B is a block diagram of an electronic device to activate keyboard-based charging to charge a battery, according to an example.

FIG. 2 is a flow diagram illustrating a method for activating keyboard-based charging to charge a battery, according to an example.

FIG. 3 is a block diagram illustrating a machine-learning (ML) model for predicting remaining battery time, according to an example.

FIG. 4 is a flow diagram illustrating another method for activating keyboard-based charging to charge a battery, according to an example.

FIG. 5 depicts a non-transitory machine-readable storage medium for activating keyboard-based charging, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Electronic devices may include memory resources and processing resources to perform computing tasks. For example, memory resources may include volatile memory (e.g., random access memory (RAM)) and non-volatile memory (e.g., read-only memory (ROM), data storage devices (e.g., hard drives, solid-state devices (SSDs), etc.) to store data and instructions. In some examples, processing resources may include circuitry to execute instructions. Examples of processing resources include a central processing unit (CPU), a graphics processing unit (GPU), or other hardware device that executes instructions.

In some examples, an electronic device may be powered by a battery. For example, an electronic device may be a mobile computing device such as a laptop computer, a tablet computer, a smartphone, etc. In some examples, the mobile device may lack an external power source (e.g., municipal electrical grid, solar power, etc.). In some examples, the electronic device may be a stationary device that is powered via battery. For example, the electronic device may be a desktop computer running off of a battery source without an external power source.

In some examples, a battery may store an electrical charge to power the electronic device. Over time, the battery may be depleted unless the battery is recharged. When the battery is depleted, the electronic device may no longer be able to operate without another source of power. The depletion of a battery to the point where an electronic device is no longer operable may be referred to as battery outage.

In some examples, battery outage during transit (e.g., when a user is away from a power source) or during a power outage (e.g., when a municipal electrical grid is offline) may negatively impact a user's experience with the electronic device. For example, battery outage may slow down work on the electronic device. Furthermore, a sudden power off of the electronic device may have many negative impacts on the electronic device. For example, data may not be saved if the electronic device runs out of power without performing a shutdown procedure. Therefore, it is better to perform a controlled shutdown procedure on the electronic device before lack of power forces a shutdown. A forced shutdown can also make an operating system of the electronic device perform repairs or go into “safe mode” when the user restarts the electronic device.

The examples described herein use a machine learning (ML) (also referred to artificial intelligence (Al)) approach to continuously monitor the battery state of an electronic device while the electronic device is not connected to power. The ML model may generate a prediction of how much time the battery will last given current conditions of the electronic device. Battery charging using a keyboard-based charger may be automatically activated based on the ML model predication. In some examples, the keyboard-based charger may be a piezoelectric charging circuit connected to the keyboard of the electronic device.

The examples described herein use ML prediction models to reduce the effect of battery outage during the unavailability of power. In some examples, based on daily usage for each user, an approximation of battery usage by the electronic device for a given user may be maintained in a database. When the ML model predicts that the electronic device will run out of battery power within a given timeframe, an alerting mechanism may generate a notification for the user, requesting the number of keystrokes to charge the battery. More usage of the keyboard would generate more energy and the battery will be charged. In the case that an external power supply becomes available, instructions may be sent to the electronic device to stop battery charging with keyboard-based charging. In some examples, in addition to ML models, a rule-based approach for event and incident management may generate a service ticket.

The examples described herein provide for monitoring of electronic device usage. For example, applications that a user uses on daily basis may be monitored. An ML-based approach may be performed to continuously monitor the battery and predict how much battery would be used by the user over a given period of time (e.g., the next 30 to 60 minutes).

In some examples, a real-time notification may be generated when the electronic device battery is low and an external power supply is unavailable. Using a combination of prediction and event monitoring, keyboard-based charging of the battery may be automatically activated with a piezoelectric keyboard.

In some examples, the keyboard-based charging may provide battery backup to the electronic device until external power is available. In this case, the keyboard-based charging may be automatically switched-off.

In some examples, information (e.g., a charging report) may be sent to a reporting database regarding the keyboard-based charging. For example, a serial number, battery serial number, battery usage during non-charging state may be sent to the reporting database in a charging report.

The present specification describes examples of an electronic device. The electronic device includes a battery to provide power to the electronic device, a keyboard, and a keyboard-based charger to charge the battery by actuation of the keyboard. The electronic device also includes a processor and memory storing instructions that cause the processor to determine that battery power is less than a threshold battery power and a power source is unavailable. The instructions also cause the processor to activate keyboard-based charging to charge the battery in response to determining that the battery power is less than the threshold battery power and a power source is unavailable. The instructions further cause the processor to generate a user notification to request keystrokes on the keyboard to charge the battery with the keyboard-based charger.

In another example, the present specification also describes an electronic device that includes a battery to provide power to the electronic device, a keyboard, and a keyboard-based charger to charge the battery by actuation of the keyboard. The electronic device also includes a processor and memory storing instructions that cause the processor to run an ML model to predict remaining battery time based on battery usage over a time period. The instructions also cause the processor to activate keyboard-based charging to charge the battery with the keyboard-based charger based on the predicted remaining battery time.

In yet another example, the present specification also describes a non-transitory machine-readable storage medium that includes instructions, when executed by a processor of an electronic device, cause the processor to predict a remaining battery time using an ML model. The instructions also cause the processor to activate keyboard-based charging to charge the battery by actuation of the keyboard in response to determining that the remaining battery time is below a time threshold. The instructions further cause the processor to generate a user notification to request keystrokes on a keyboard.

As used in the present specification and in the appended claims, the term “processor” may be a processor resource, a controller, an application-specific integrated circuit (ASIC), a semiconductor-based microprocessor, a central processing unit (CPU), and a field-programmable gate array (FPGA), and/or other hardware device that executes instructions.

As used in the present specification and in the appended claims, the term “memory” may include a computer-readable storage medium, which computer-readable storage medium may contain, or store computer-usable program code for use by or in connection with an instruction execution system, apparatus, or device. The memory may take many types of memory including volatile memory (e.g., RAM) and non-volatile memory (e.g., ROM).

As used in the present specification and in the appended claims, the term “data storage device” may include a non-volatile computer-readable storage medium . . . Examples of the data storage device include hard disk drives, solid-state drives, writable optical memory disks, magnetic disks, among others. The executable instructions may, when executed by the respective component, cause the component to implement the functionality described herein.

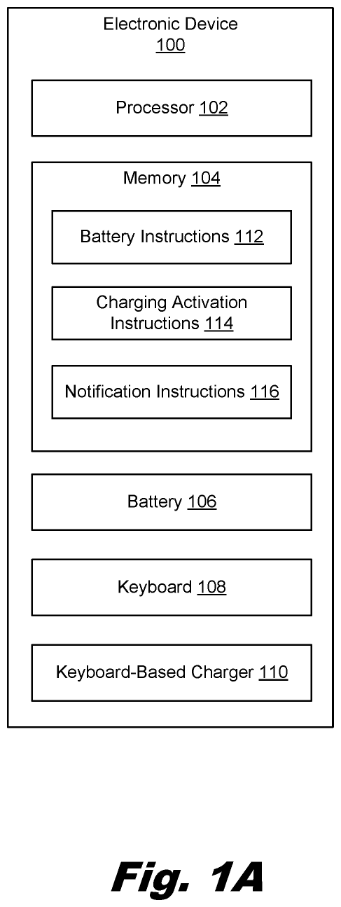

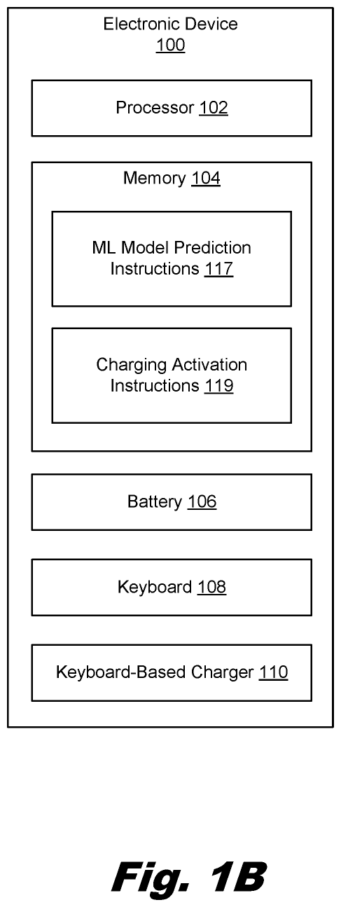

Turning now to the figures, FIG. 1A is a block diagram of an electronic device 100 to activate keyboard-based charging to charge a battery 106, according to an example. As used herein, an electronic device 100 may include a laptop computer, desktop computer, tablet computer, server, workstation, smartphone, router, gaming console, or other device having memory resources and processing resources.

As described above, the electronic device 100 includes a processor 102. The processor 102 of the electronic device 100 may be implemented as dedicated hardware circuitry or a virtualized logical processor. The dedicated hardware circuitry may be implemented as a central processing unit (CPU). A dedicated hardware CPU may be implemented as a single to many-core general purpose processor. A dedicated hardware CPU may also be implemented as a multi-chip solution, where more than one CPU are linked through a bus and schedule processing tasks across the more than one CPU.

A virtualized logical processor may be implemented across a distributed computing environment. A virtualized logical processor may not have a dedicated piece of hardware supporting it. Instead, the virtualized logical processor may have a pool of resources supporting the task for which it was provisioned. In this implementation, the virtualized logical processor may be executed on hardware circuitry; however, the hardware circuitry is not dedicated. The hardware circuitry may be in a shared environment where utilization is time sliced. Virtual machines (VMs) may be implementations of virtualized logical processors.

In some examples, a memory 104 may be implemented in the electronic device 100. The memory 104 may be dedicated hardware circuitry to host instructions for the processor 102 to execute. In another implementation, the memory 104 may be virtualized logical memory. Analogous to the processor 102, dedicated hardware circuitry may be implemented with dynamic random-access memory (DRAM) or other hardware implementations for storing processor instructions. Additionally, the virtualized logical memory may be implemented in an abstraction layer which allows the instructions to be executed on a virtualized logical processor, independent of any dedicated hardware implementation.

The electronic device 100 may also include instructions. The instructions may be implemented in a platform specific language that the processor 102 may decode and execute. The instructions may be stored in the memory 104 during execution. The instructions may include battery instructions 112, charging activation instructions 114 and notification instructions 116, according to the examples described herein.

In some examples, the electronic device 100 may include a battery 106. For example, the battery 106 may provide electrical power to the electronic device 100 when the electronic device 100 is disconnected from an external power source. In some examples, the battery 106 may be a rechargeable battery. In this case, the battery 106 may be charged when the electronic device 100 is connected to an external power supply or other charging device.

In some examples, the electronic device 100 may include a keyboard 108. In some examples, a keyboard 108 may be a device that includes a number of mechanical buttons (i.e., the keys). A user may actuate the mechanical buttons to send signals to the electronic device 100.

In some examples, the keyboard 108 may be integrated into the electronic device 100. For example, in the case of a laptop computer, the keyboard 108 may be included in the case of the laptop computer. In some examples, the keyboard 108 may be separate from the electronic device 100, but may be attached to the electronic device 100 with a physical connection (e.g., a cord).

In some examples, the electronic device 100 may include a keyboard-based charger 110. In some examples, the keyboard-based charger 110 may include circuitry to charge the battery 106 in response to actuation of the keyboard 108. As used herein, actuation of the keyboard 108 may include pressing the keys of the keyboard 108. For example, a user may actuate the keyboard 108 by typing on the keys of the keyboard 108. When a force is exerted on a key of the keyboard, the key may travel through a distance. A bias mechanism (e.g., a spring) may apply a counter force to return the key to a starting position.

In some examples, the keyboard-based charger 110 may use the force applied to the keys of the keyboard 108 to generate electricity. In some examples, the keyboard-based charger 110 may include a piezoelectric generator. In some examples, the piezoelectric generator may include circuitry embedded beneath the keys of the keyboard 108. The circuitry may include a piezoelectric material. When the user presses the keyboard keys, electricity is generated in response to a stress applied to the piezoelectric material. This process may be referred to as a direct piezoelectric effect. As stress is applied across the piezoelectric material (e.g., a crystal), an electric potential appears on the faces of the piezoelectric material due to the displacement of ions in the piezoelectric material that has a non-symmetrical unit cell. The compression on the piezoelectric material displaces the ions in each cell causing electric polarization, which results in an electric charge accumulation on the faces of the piezoelectric material. The potential difference across the piezoelectric material creates an electric voltage, which may be used to charge the battery 106.

It should be noted that with a piezoelectric material, the electronic device may be powered without an external power source due to the ability of the piezoelectric material to produce a voltage when acted upon by a force. Piezoelectric materials may also provide for installation in small dimensions. Therefore, piezoelectric materials may be installed in high-density electronic devices. Furthermore, piezoelectric materials are highly flexible and can be constructed in a wide variety of shapes and sizes.

In some examples, keyboard-based charging may be activated and deactivated. In some examples, activating the keyboard-based charging may include determining that a battery 106 is low and requesting that a user provide keystrokes to charge the battery 106 with the keyboard-based charger 110. For example, when the electronic device 100 is being powered by an external power source, or when the battery 106 is charged above a threshold battery power, user actuation of the keyboard-based charger 110 may avoided. In this case, the electronic device 100 may operate without charging by the keyboard-based charger 110. However, the keyboard-based charging may be activated to charge the battery 106 when the battery charge is less than a threshold battery power. In this case, the processor 102 may determine that the battery 106 is low and charging with the keyboard-based charger 110 may be used to avoid a forced shutdown of the electronic device 100. In some examples, the battery 106 may include circuitry and instructions to stop charging after it reaches full capacity.

In some examples, the processor 102 may execute the battery instructions 112 that cause the processor 102 to determine that battery power is less than a threshold battery power and a power source is unavailable. For example, the electronic device 100 may be disconnected from an external power source, or the external power source may be disabled. In this situation, the electronic device 100 may run on power provided by the battery 106. Over time, the battery 106 may become depleted unless a power source is provided.

In some examples, the processor 102 may run an ML model to predict remaining battery time based on battery usage over a time period. For example, the processor 102 may implement a ML model to predict how much time the battery 106 may continue to power the electronic device 100 based on historic usage of the electronic device 100. In some examples, the remaining battery time may be a predicted amount of time that the battery 106 can continue to power the electronic device 100. For example, the ML model may predict that the battery 106 can provide a number of minutes (e.g., 30 minutes, 60 minutes, etc.) based on the current battery state and system resource usage (e.g., memory usage, processor usage, display usage, etc.).

It should be noted that the remaining battery time predicted by the ML model differs from the battery capacity. For example, a battery 106 with 50% capacity may not indicate a time before the battery 106 is depleted as this timeframe is based on a number of factors such as the resources (e.g., memory, processor, input/output devices, etc.) operating on the electronic device 100, the applications running on the electronic device 100, and the state of the battery 106 (e.g., temperature, charge/discharge rate, age of battery 106, etc.).

In some examples, the ML model may be trained to output a prediction of remaining battery time (e.g., an amount of time that the battery 106 can power the electronic device 100) based on the current state of the electronic device 100 and historic usage of the battery 106. For example, the ML model may be trained to predict the remaining battery time based on the applications running on the processor, the temperature of the battery 106, the remaining capacity of the battery 106, and a charge/discharge rate of the battery 106.

With regard to the applications running on the processor, a given applications (e.g., programs, executable instructions, etc.) may use a given amount of power. For example, a first application may consume a large amount of power, while a second application may consume a small amount of power. Therefore, a prediction for remaining battery time may factor in currently running applications.

With regard to the temperature, the temperature of the battery 106 may impact the efficiency and performance of the battery 106. For example, cold temperatures may decrease the amount of power that a battery 106 is able to provide. On the other hand, warm temperatures may increase the amount of power that a battery 106 is able to provide. Therefore, a prediction for remaining battery time may factor in the temperature of the battery 106.

The remaining capacity of the battery 106 may be used to predict the remaining battery time in terms of an amount of time that the battery 106 can continue to power the electronic device 100. As used herein, battery capacity may be the total amount of charge that the battery 106 can deliver. Remaining capacity refers to the present amount of charge that the battery 106 can deliver. In some examples, the remaining capacity of the battery 106 may be expressed as a ratio (e.g., percentage) of battery power remaining. For example, if the battery 106 is half depleted, then the remaining capacity of the battery 106 may be 50%.

The charge/discharge rate of the battery 106 may affect the battery capacity. For example, if the battery 106 is being discharged very quickly (i.e., the discharge current is high), then the amount of energy that can be extracted from the battery 106 may be reduced and the battery capacity is lower. Conversely, if the battery 106 is discharged at a very slow rate using a low current, more energy may be extracted from the battery 106 and the battery capacity is higher. Therefore, the remaining battery time may be predicted based on the charging/discharging rate of the battery 106.

In some examples, the age and history of the battery 106 may impact the capacity of the battery 106. For example, the physical and chemical structures of the battery 106 may degrade over time. Therefore, a new battery 106 may provide more power than an older battery 106. Thus, the age of the battery 106 may be used to predict the remaining battery time.

In some examples, the ML model may determine the remaining battery time based on battery usage over a number of days. For example, the ML model may learn battery usage patterns over a number (e.g., 15) days. For example, a user may use a set of application and resources (e.g., CPU, memory) over a number of days. The ML model may map energy consumption on the electronic device 100 over a number of days to battery usage. In some examples, the ML model may determine how the battery 106 is depleted while monitoring the applications running on the processor, the temperature of the battery 106, the remaining capacity of the battery 106, and a charge/discharge rate of the battery 106 over the course of a number of days.

The ML model may receive the current state of the battery 106 and the current system resource state (e.g., currently running applications, CPU usage, memory usage, etc.). The ML model may then predict the remaining battery time based on the current battery state and current system resource state. In some examples, the ML model may output a predicted amount of time remaining before the battery 106 is depleted. In some examples, the remaining battery time may be referred to as the remaining battery power.

In some examples, the processor 102 may determine that battery power is less than a threshold battery power. In some examples, the threshold battery power may be a time threshold for an amount of time (e.g., a number of minutes) that the battery 106 is to provide power to the electronic device 100. For example, the processor 102 may determine that the predicted remaining battery time is less than a time threshold. If the processor 102 determines that the predicted remaining battery time is less than the time threshold, then the processor 102 may determine that the current battery power is less than the threshold battery power.

In some examples, the processor 102 may execute charging activation instructions 114 that cause the processor 102 to activate keyboard-based charging to charge the battery 106. For example, in response to determining that the battery power is less than the threshold battery power and a power source is unavailable, the processor 102 may activate keyboard-based charging. In some examples, activating keyboard-based charging may include determining to request user actuation of the keyboard 108 such that the keyboard-based charger 110 is activated to charge the battery 106. Once activated, keyboard-based charger 110 may begin to charge the battery 106 when keys of the keyboard 108 are pressed.

In some examples, the processor 102 may activate keyboard-based charging to charge the battery 108 based on the predicted remaining battery time determined by the ML model. For example, the ML model may predict a remaining battery time. If the predicted remaining battery time is less than the time threshold, then the processor 102 may request user activation of the keyboard-based charger 110.

In some examples, the processor 102 may execute notification instructions 116 that cause the processor 102 to generate a user notification to request keystrokes on the keyboard 108 to charge the battery 106 with the keyboard-based charger 110. For example, the processor 102 may cause a notification to be displayed on the screen of the electronic device 100 instructing the user to type on the keyboard 108 to charge the battery 106.

In some examples, the user notification may indicate a number of keystrokes to fully charge the battery 106. For example, the ML model may predict the number of keystrokes to fully charge the battery using the keyboard-based charger. In some examples, the ML model may include a boosted regression tree model to predict the number of keystrokes to fully charge the battery using the keyboard-based charger. In some examples, the ML model may receive key press count data by monitoring user keystrokes on the keyboard 108. The ML model may also monitor battery charging differences over a period of time. Using the historical information about user keystrokes and battery charging, the ML model may predict the number of keystrokes that will charge the battery 106 to full capacity from the current battery level.

In some examples, the processor 102 may deactivate keyboard-based charging in response to determining that the battery power is greater than the threshold battery power or a power source is available. For example, using the keyboard-based charger 110, the user may charge the battery 106 above the threshold battery power. Furthermore, at some point, an external power source may become available to charge the battery 106. In this case, the processor 102 may deactivate keyboard-based charging. For example, the processor 102 may generate a second user notification to indicate that keyboard-based charging is deactivated in response to determining that the battery power is greater than the threshold battery power or a power source is available.

In some examples, the processor 102 may perform power-saving operations to conserve battery power based on the predicted remaining battery time. For example, if the processor 102 determines that the predicted remaining battery time is less than a time threshold, the processor 102 may reduce screen brightness, turn off keyboard backlights, turn off wireless communication (e.g., Bluetooth, Wi-Fi, etc.). In some examples, the processor 102 may provide a list of applications not in use or consuming battery heavily. A user may can close these applications to reduce the CPU load. In some examples, the processor 102 may disable USB ports or other input/output devices to further conserve battery power.

In some examples, the processor 102 may generate a notification to the user to perform a power-saving operation based on the predicted remaining battery time. For example, a message may prompt the user to reduce the screen brightness, remove external devices connected which are consuming the battery 106, turn off the screen, reduce the sleep time based on the time the screen remains idle, turn off the keyboard light when not in use, or a combination thereof.

The described examples may enhance the overall usage experience of the electronic device 100 by providing enhanced battery life and avoiding downtime due to battery depletion. These examples may also prevent data loss and may provide battery power during a power outage or when there is no access to a power source. In some examples, a user may charge the electronic device 100 to retain access to data and functionality on the electronic device 100. Furthermore, the described examples may reduce user complaints about low battery availability.

FIG. 1B is a block diagram of an electronic device 100 to activate keyboard-based charging to charge a battery 106, according to an example. In some examples, the electronic device 100 may be implemented according to the electronic device 100 of FIG. 1A. For example, the electronic device 100 of FIG. 1B may include a processor 102, memory, a battery 106, a keyboard, and a keyboard-based charger 110, as described in FIG. 1A.

In FIG. 1B, the memory 104 may store instructions for the processor 102 to execute. For example, the processor 102 may execute ML model prediction instructions 117 that cause the processor 102 to run a ML model to predict remaining battery time based on battery usage over a time period. As described above, the processor 102 may implement a ML model to predict how much time the battery 106 may continue to power the electronic device 100 based on historic usage of the electronic device 100. In some examples, the remaining battery time may be a predicted amount of time that the battery 106 can continue to power the electronic device 100. For example, the ML model may predict that the battery 106 can provide a number of minutes (e.g., 30 minutes, 60 minutes, etc.) based on the current battery state and system resource usage (e.g., memory usage, processor usage, display usage, etc.).

The processor 102 may execute charging activation instructions 114 that cause the processor 102 to activate keyboard-based charging to charge the battery 106 with the keyboard-based charger 110 based on the predicted remaining battery time. In some examples, if the predicted remaining battery time is less than a time threshold, then the processor 102 may request user activation of the keyboard-based charger 110.

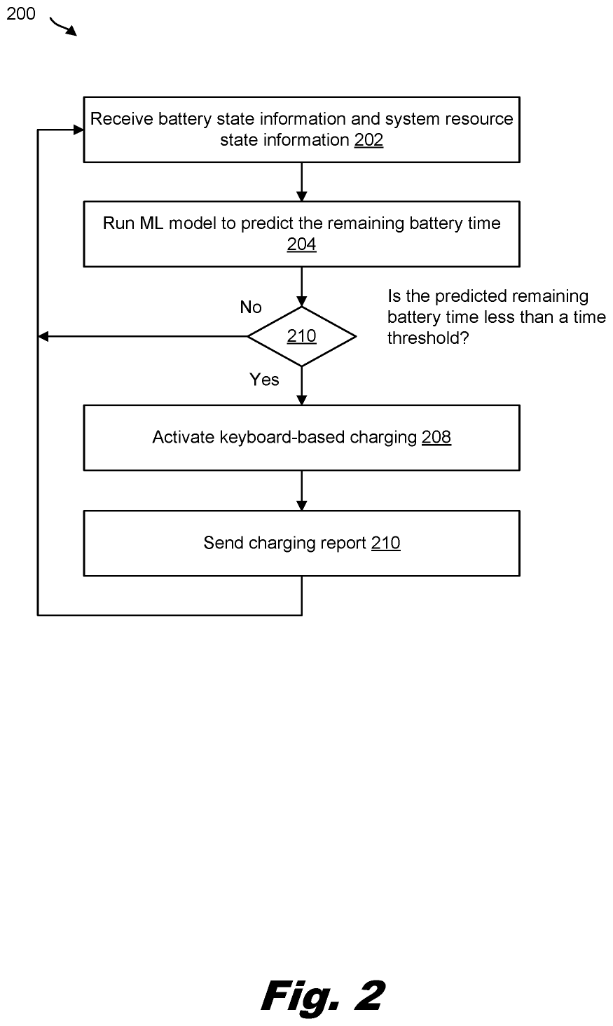

FIG. 2 is a flow diagram illustrating a method 200 for activating keyboard-based charging to charge a battery, according to an example. In some examples, the method 200 may be performed by a processor, such as the processor 102 of FIG. 1A or FIG. 1B.

At 202, battery state information and system resource state information may be received. In some examples, the battery state information may include the temperature of the battery, remaining capacity of the battery, and a charge/discharge rate of the battery. In some examples, the battery state information may be collected by a battery management system of the electronic device. The system resource state information may include a list of applications running on the processor.

At 204, an ML model may be run to predict the remaining battery time. In some examples, the remaining battery time is a predicted amount of time remaining before the battery is depleted.

In some examples, the ML model may be a Boosted Regression Tree model, which can be used for predicting the number of keystrokes to completely charge the battery. In some examples, boosted regression trees combine the strengths of two approaches: regression trees (e.g., models that relate a response to their predictors by recursive binary splits) and boosting (e.g., an adaptive method for combining many simple models to give enhanced predictive performance).

In some examples, the electronic device may generate a report with various features and attributes related to battery state and system resource state. Table 1 provides examples of attributes that a given electronic device may report.

TABLE 1

| Data Category | Field |
|---|---|
| Hardware | Device Type |
| Inventory | Device Manufacturer |
| | Device Model |
| | Operating System |
| | Operating System Release |
| | Operating System Build No |
| | Operating System Edition |
| | Operating System Type |
| | Last Seen |
| | Manufacture Date |
| | Born On Date |
| | Enrolled Date |
| Battery | Battery SN |
| | Battery CT Number |
| | Battery Instance |
| | Temperature |
| | Remaining Capacity |
| | Full charge Capacity |
| | Cycle Count |
| | Charge Rate |
| | Discharge Rate |
| Display/Monitors | Display Type |
| | Display Model |
| | Status |
| Application and | Application Name |
| Hardware Usage | Daily CPU Usage |
| | Daily Memory Usage |
| | Top application consuming battery |
| | Screen resolution, brightness |
| | Projector |
| | External device |
| | Keyboard light |

It should be noted that while several different examples of battery state attributes and system resource state attributes are included in Table 1, an electronic device may report a subset of these examples, or other types of usage data. At 204, the ML model may predict the remaining battery time using the reported attributes of Table 1 or a subset of the attributes.

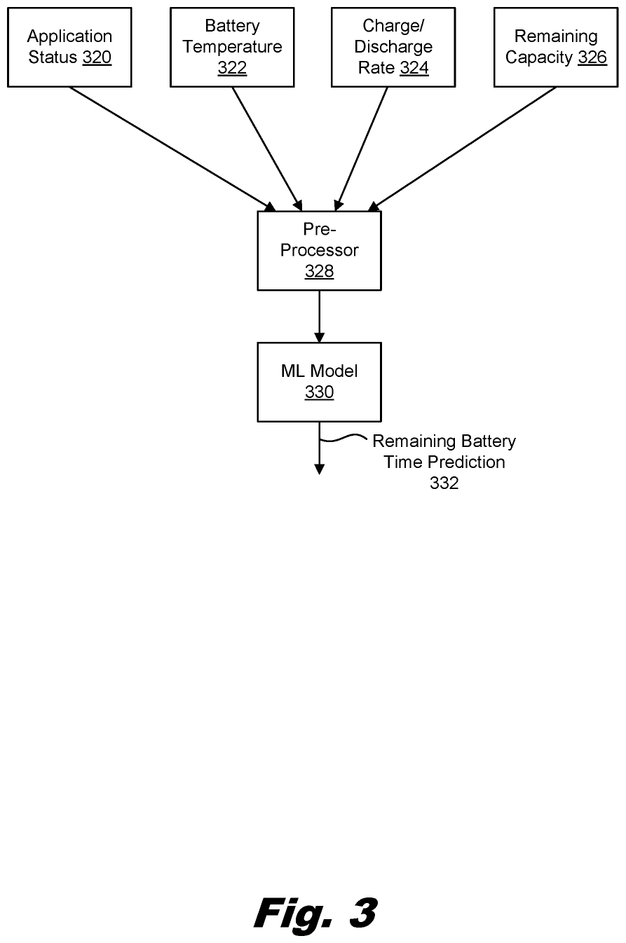

In some examples, the initial phase of predicting the remaining battery time may start with the data collected from various devices coming into a database (e.g., a cloud database). The database may aggregate the data and group the data based on common properties. Features may be extracted from the data and fed into the ML model to perform battery life and usage calculations. Data from both models may be combined to form a single vector fee to another ML model that takes this vector as input and another from a knowledge database (e.g., domain expert) to derive an inference about the battery condition. Further examples of training and running the ML model are described in FIG. 3.

At 206, a determination may be made whether the predicted remaining battery time is less than a time threshold. For example, the time threshold may be an amount of time that the battery is to provide power to the electronic device. If the predicted remaining battery time is greater than the time threshold (206 determination NO), then the battery state information and system resource state information may continue to be monitored at 202.

If the predicted remaining battery time is less than the time threshold (206 determination YES), then the keyboard-based charging may be activated, at 208. In some examples, a user notification may be generated to request keystrokes on the keyboard to charge the battery.

At 210, a charging report may be sent. In some examples, the processor may send a report indicating that the battery was charged by the keyboard-based charger. The report may be sent to a reporting database. In some examples, the charging report may be collected with reports from other electronic devices that experience an instance of charging by the keyboard-based charger. The collected charging reports may be used to evaluate the outcome and efficiency of the keyboard-based charging.

FIG. 3 is a block diagram illustrating an ML model 330 for predicting remaining battery time, according to an example. In some examples, a pre-processor 328 may receive application status information 320, the battery temperature 322, the battery charge/discharge rate 324, and the remining capacity 326 of the battery. In some examples, the data collection may come from data source(s) as illustrated in the attribute list of Table 1.

The pre-processor 328 may create a dataset(s) with features for the ML model 330. The pre-processor 328 may clean the data through removing outliers. The pre-processor 328 may impute the data through different statistical process such as mean, previous entry, next entry, most frequent, feature similarity techniques. The pre-processor 328 may remove collinear, zero importance features.

The pre-processor 328 may provide the processed data to the ML model 330. In some examples, the ML model 330 may include a KNN (k nearest neighbor), decision trees, a random forest or a boosted regression tree.

In an example, a boosted regression tree may be used to create an ensemble of regression trees using boosting. With boosting, each tree is dependent on prior trees. This process learns by fitting the residual of the trees that preceded it. Thus, boosting in a decision tree ensemble tends to increase accuracy with some small risk of less coverage. Each regression tree may be built in a stepwise fashion, using a predefined loss function to measure the error in each step and correct for it in the next.

In some examples, the trained ML model 330 may be deployed within an analytics pipeline to produce daily results. In some examples, a number of days (e.g., the past 15 days) of data may be collected for all the batteries that are to be considered. Pre-processing that includes cleansing of input data is performed on data that is to be passed to the ML model 330 for prediction. In some examples, the ML model 330 may output a remaining battery time prediction 332 in the form of a predicted amount of time that the battery can power the electronic device.

In some examples, the ML model 330 may also output results in the form of a numeric value that indicates how many keystrokes are to fully charge the battery. The ML model 330 may consider the current running applications 320, temperature 322 of the battery, remaining capacity 326 of the battery, charge, and discharge rate 326 for predicting the keystrokes for fully charging the battery.

As with random forest models, boosted regression trees (BRTs) may repeatedly fit many decision trees to increase the accuracy of the ML model 330. One of the differences between these two methods is the way in which the data to build the trees is selected. Forest models may use the bagging method, where each occurrence has an equal probability of being selected in subsequent samples. BRTs may use the boosting method in which the input data are weighted in subsequent trees. The weights are applied in such a way that data that was poorly modelled by previous trees has a higher probability of being selected in the new tree.

In some examples, the ML model 330 will include training as well as retraining of the model in case of low accuracy. By considering the fit of previous trees that are built, the ML model 330 continuously tries to increase its accuracy.

To train the ML model 330, three types of data may be used: training data, test data, and validation data. The training dataset may be used to train the ML model 330. A part of the dataset may be reserved to validate the ML model 330. Before validation, the ML model 330 may be tested with the test dataset.

In some examples, the dataset may be divided into 80% training data and 20% test data. In some examples, 20% of the training set may be used for a first validation before the definitive validation is performed by the validation service. After the training with the selected features, the ML model 330 is evaluated. When the resulting metrics are satisfactory, the ML model 330 may be saved.

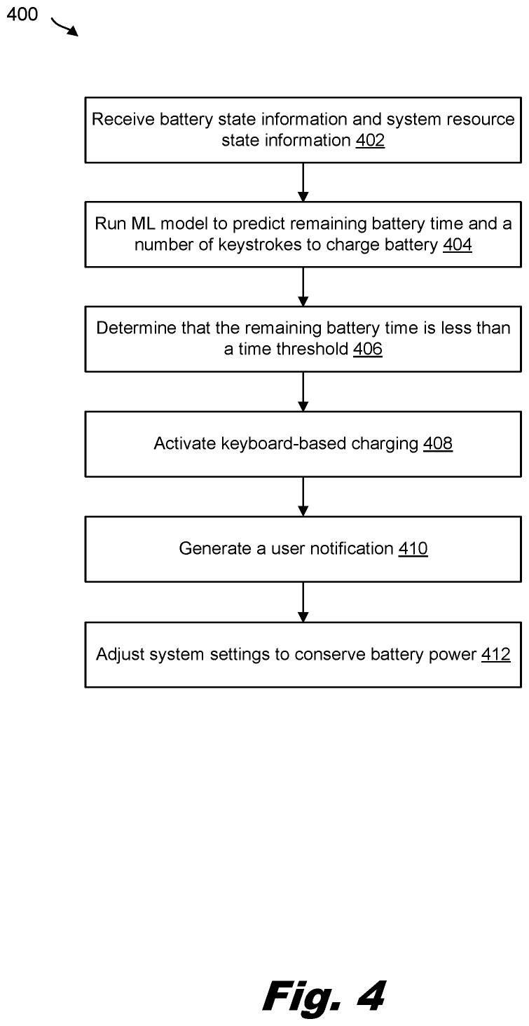

FIG. 4 is a flow diagram illustrating another method 400 for activating keyboard-based charging to charge a battery, according to an example. In some examples, the method 400 may be performed by a processor, such as the processor 102 of FIG. 1.

At 402, battery state information and system resource state information may be received. In some examples, the battery state information and system resource state information may include applications running on the processor, temperature of the battery, remaining capacity of the battery, and a charge/discharge rate of the battery.

At 404, an ML model may be run to predict the remaining battery time and a number of keystrokes to charge battery. In some examples, the remaining battery time is a predicted amount of time remaining before the battery is depleted. In some examples, the ML model may predict the number of keystrokes to fully charge the battery using a keyboard-based charger.

At 406, a determination may be made that the remaining battery time is less than a time threshold. In an example, the ML model may determine that the remaining battery time is 20 minutes until the battery is depleted based on current system resource usage. In this example, the time threshold may be 30 minutes. In this case, the predicted remaining batter time is less than the time threshold.

At 408, keyboard-based charging may be activated. For instance, the processor may determine that sustained activation of the keyboard-based charger may be used to charge the battery. As used herein, sustained activation may include a user entering a number of keystrokes within a period of time, with a minimum frequency, or a combination of both.

At 410, a user notification may be generated. For example, the user notification may indicate that the battery is low. The user notification may also request that the user provide keystrokes on the keyboard to charge the battery. The user notification may further indicate the number of keystrokes to fully charge the battery.

At 412, system settings may be adjusted to conserve battery power in response to the predicted remaining battery time. For example, the processor may reduce screen brightness, turn off keyboard backlights, turn off wireless communication (e.g., Bluetooth, Wi-Fi, etc.). In some examples, the processor may provide a list of applications not in use or consuming battery heavily. A user may can close these applications to reduce the CPU load. In some examples, the processor may disable USB ports or other input/output devices to further conserve battery power.

In some examples, the processor may generate a notification to the user to perform a power-saving operation based on the predicted remaining battery time. For example, a message may be prompted to the user to reduce the screen brightness, remove external devices connected which are consuming the battery, turn off the screen, reduce the sleep time based on the time the screen remains idle, turn off the keyboard light when not in use, or a combination thereof.

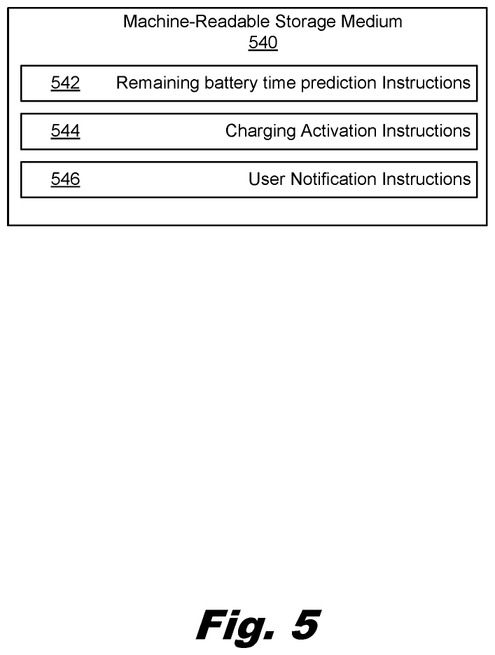

FIG. 5 depicts a non-transitory machine-readable storage medium 540 for activating keyboard-based charging, according to an example. To achieve its desired functionality, an electronic device 100 includes various hardware components. Specifically, an electronic device includes a processor and a machine-readable storage medium 540. The machine-readable storage medium 540 is communicatively coupled to the processor. The machine-readable storage medium 540 includes a number of instructions 542, 544, 546 for performing a designated function. The machine-readable storage medium 540 causes the processor to execute the designated function of the instructions 542, 544, 546. The machine-readable storage medium 540 can store data, programs, instructions, or any other machine-readable data that can be utilized to operate the electronic device 100. Machine-readable storage medium 540 can store computer readable instructions that the processor of the electronic device 100 can process or execute. The machine-readable storage medium 540 can be an electronic, magnetic, optical, or other physical storage device that contains or stores executable instructions. Machine-readable storage medium 540 may be, for example, Random Access Memory (RAM), an Electrically Erasable Programmable Read-Only Memory (EEPROM), a storage device, an optical disc, etc. The machine-readable storage medium 540 may be a non-transitory machine-readable storage medium 540, where the term “non-transitory” does not encompass transitory propagating signals.

Referring to FIG. 5, remaining battery time prediction instructions 542, when executed by the processor, may cause the processor to predict a remaining battery time using an ML model. Charging activation instructions 544, when executed by the processor, may cause the processor to activate keyboard-based charging to charge the battery by actuation of the keyboard in response to determining that the remaining battery time is below a time threshold. User notification instructions 546, when executed by the processor, may cause the processor to generate a user notification to request keystrokes on a keyboard.

In some examples, the ML model is to predict the remaining battery time based on applications running on the processor, temperature of the battery, remaining capacity of the battery, and a charge/discharge rate of the battery. In some examples, the ML model is to determine the remaining battery time based on battery usage over a number of days. In some examples, the ML model is to further determine a number of keystrokes to fully charge the battery using the keyboard-based charger. In some examples, the ML model may include a boosted regression tree model to predict the number of keystrokes to fully charge the battery using the keyboard-based charger.

What is claimed is:

1. An electronic device, comprising:
a battery to provide power to the electronic device;
a keyboard;
a keyboard-based charger to charge the battery by actuation of the keyboard;
a processor; and
a memory communicatively coupled to the processor and storing executable instructions that when executed cause the processor to:
determine that a battery power is less than a threshold battery power and a power source is unavailable;
activate keyboard-based charging to charge the battery in response to determining that the battery power is less than the threshold battery power and a power source is unavailable; and
generate a user notification to request keystrokes on the keyboard to charge the battery with the keyboard-based charger.

2. The electronic device of claim 1, wherein the keyboard-based charger comprises a piezo-electricity generator connected to keys of the keyboard.

3. The electronic device of claim 1, wherein the user notification indicates a number of keystrokes to fully charge the battery.

4. The electronic device of claim 1, further comprising executable instructions to cause the processor to:
deactivate keyboard-based charging in response to determining that the battery power is greater than the threshold battery power or a power source is available.

5. The electronic device of claim 1, further comprising executable instructions to cause the processor to:
generate a second user notification to indicate that keyboard-based charging is deactivated in response to determining that the battery power is greater than the threshold battery power or a power source is available.

6. An electronic device, comprising:
a battery to provide power to the electronic device;
a keyboard;
a keyboard-based charger to charge the battery by actuation of the keyboard;
a processor; and
a memory communicatively coupled to the processor and storing executable instructions that when executed cause the processor to:
run a machine-learning (ML) model to predict remaining battery time based on battery usage over a time period; and
activate keyboard-based charging to charge the battery with the keyboard-based charger based on the predicted remaining battery time.

7. The electronic device of claim 6, wherein the ML model is trained to predict the remaining battery time based on applications running on the processor, temperature of the battery, remaining capacity of the battery, and a charge/discharge rate of the battery.

8. The electronic device of claim 6, wherein the ML model predicts the remaining battery time based on a current battery state and a history of applications used on the electronic device.

9. The electronic device of claim 6, wherein the electronic device comprises a mobile computing device lacking an external power source.

10. The electronic device of claim 6, wherein the executable instructions to activate keyboard-based charging comprise executable instructions to cause the processor to:
predict, using the ML model, that the remaining battery time is less than a time threshold; and
generate a user notification to request keystrokes on the keyboard to charge the battery with the keyboard-based charger.

11. A non-transitory computer readable medium comprising machine readable instructions that when executed cause a processor to:
predict a remaining battery time using a machine-learning (ML) model;
activate keyboard-based charging to charge the battery by actuation of the keyboard in response to determining that the remaining battery time is below a time threshold; and
generate a user notification to request keystrokes on a keyboard.

12. The computer readable medium of claim 11, wherein the ML model is to determine the remaining battery time based on battery usage over a number of days.

13. The computer readable medium of claim 11, wherein the ML model is to predict the remaining battery time based on applications running on the processor, temperature of the battery, remaining capacity of the battery, and a charge/discharge rate of the battery.

14. The computer readable medium of claim 11, wherein the ML model is to further determine a number of keystrokes to fully charge the battery using the keyboard-based charger.

15. The computer readable medium of claim 11, wherein the ML model comprises a boosted regression tree model to predict the number of keystrokes to fully charge the battery using the keyboard-based charger.
